(19) United States
(12) Patent Application Publication
(10) Pub. No.: US 2019/0204119 A1
(43) Pub. Date: Jul. 4, 2019

(54) SCALE AND MANUFACTURING METHOD OF THE SAME

(71) Applicant: MITUTOYO CORPORATION, Kawasaki (JP)

(72) Inventor: Toshihiko Aoki, Kawasaki (JP)

(21) Appl. No.: 16/229,992

(22) Filed: Dec. 21, 2018

(30) Foreign Application Priority Data
Dec. 28, 2017 (JP) 2017-252987

(51) Int. Cl. G01D 5/347; G01D 5/38; G02B 5/18

(52) U.S. Cl. CPC G01D 5/34707; G02B 5/1861; G02B 5/1857; G01D 5/38

(57) ABSTRACT

A scale includes: a substrate; a first metal layer formed on the substrate; a second metal layer formed on the first metal layer; and scale gratings that are formed on the second metal layer and have a plurality of metal gratings at a predetermined interval, wherein the first metal layer is made of a first metal, wherein the second metal layer is made of a second metal, wherein adhesion of the first metal with the substrate is higher than adhesion of the second metal with the substrate, and wherein a reflectivity of the second metal with respect to a wavelength of a used light is higher than a reflectivity of the first metal layer with respect to the wavelength of the used light.

### CROSS-REFERENCE TO RELATED APPLICATION

This application is based upon and claims the benefit of priority of the prior Japanese Patent Application No. 2017-252987, filed on Dec. 28, 2017, the entire contents of which are incorporated herein by reference.

### FIELD

A certain aspect of embodiments described herein relates to a scale and a manufacturing method of a scale.

### BACKGROUND

A scale having a scale gratings for reflecting an incident light is disclosed as a photoelectric linear scale of reflection type (for example, see Japanese Patent Application Publication No. 2005-308718). The scale has a phase grating structure using a level difference between an upper face and a lower face of gratings. The scale gratings have a convexoconcave shape having a predetermined level difference with respect to a base. Therefore, when a contaminant adhering to the scale is removed by wiping or the like, the scale gratings may be damaged. The contaminant may be left in a recess between scale gratings during wiping. In this case, measurement accuracy may be degraded. When the scale gratings have a micro size, the measurement accuracy may be remarkably degraded. And so, there is disclosed a technology in which a protective layer covers the convexoconcave shape of scale gratings (for example, see Japanese Patent Application Publication No. 2006-178312).

### SUMMARY

However, when a protective layer is provided, it is mathematically apparent that a diffracted light is weaker than a case where the protective layer is not provided, because of reflection or absorption at an interface between a surface of the protective layer and a metal of a ground layer. And so, it is thought that a high reflectivity metal is selected as a material structuring reflection type phase gratings. However, types of the high reflectivity metal are limited, when adhesion with the substrate is considered.

In one aspect of the present invention, it is an object to provide a scale that is capable of achieving high diffraction efficiency and having high adhesion with a substrate and a manufacturing method of the scale.

According to an aspect of the present invention, there is provided a scale including: a substrate; a first metal layer formed on the substrate; a second metal layer formed on the first metal layer; and scale gratings that are formed on the second metal layer and have a plurality of metal gratings at a predetermined interval, wherein the first metal layer is made of a first metal, wherein the second metal layer is made of a second metal, wherein adhesion of the first metal with the substrate is higher than adhesion of the second metal with the substrate, and wherein a reflectivity of the second metal with respect to a wavelength of a used light is higher than a reflectivity of the first metal layer with respect to the wavelength of the used light.

According to another aspect of the present invention, there is provided a manufacturing method of a scale including: forming a first metal layer, a second metal layer, and a metal scale grating layer on a substrate in this order; and forming scale gratings having a plurality of metal gratings at a predetermined interval, by etching the metal scale grating layer, wherein the first metal layer is made of a first metal, wherein the second metal layer is made of a second metal, wherein adhesion of the first metal with the substrate is higher than adhesion of the second metal with the substrate, and wherein a reflectivity of the second metal with respect to a wavelength of a used light is higher than a reflectivity of the first metal layer with respect to the wavelength of the used light.

### BRIEF DESCRIPTION OF DRAWINGS

FIG. 1A illustrates a plan view of a scale of a first embodiment;

FIG. 1B illustrates a cross sectional view taken along a line A-A of FIG. 1A; and

FIG. 2A to FIG. 2E illustrate a manufacturing method of a scale.

### DESCRIPTION OF EMBODIMENTS

The following is a description of embodiments, with reference to the accompanying drawings.

### First Embodiment

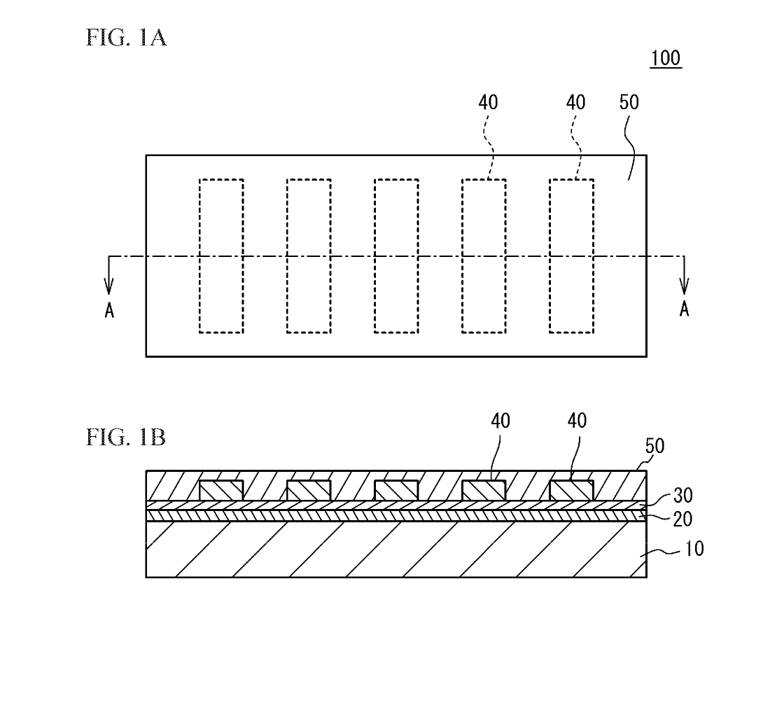

FIG. 1A illustrates a plan view of a scale 100 in accordance with a first embodiment. FIG. 1B illustrates a cross sectional view taken along a line A-A of FIG. 1A. As illustrated in FIG. 1A and FIG. 1B, the scale 100 has a structure in which an adhesive layer 20 acting as a first metal layer is formed on a substrate 10, a high reflection layer 30 acting as a second metal layer is formed on the adhesive layer 20, scale gratings 40 having metal gratings at a predetermined interval are formed on the high reflection layer 30, and a protective layer 50 covers the scale gratings 40 and an exposed portion of the high reflection layer 30.

The substrate 10 is not limited. The substrate 10 is, for example, made of a material other than a metal. For example, the material is metal oxide, organic material, glass and so on. The glass may be a low expansion coefficient material such as quartz glass (synthetic molten quartz).

The adhesive layer 20 is made of a first metal. The high reflection layer 30 is made of a second metal. Adhesion of the first metal with the substrate 10 is higher than adhesion of the second metal with the substrate 10. “A metal having high adhesion” among a plurality of metals means a metal having relatively high adhesion with the substrate 10 on a presumption that the plurality of metals are formed on the substrate 10 by an identical deposition method. However, even if a specific metal is deposited by a plurality of different deposition methods, a width of obtained adhesion is small. Therefore, even if each of the plurality of metals is deposited by a different deposition method, an order of the adhesion is constant. A reflectivity of the second metal with respect to a wavelength of a used light is higher than a reflectivity of the first metal with respect to the wavelength of the used light. The adhesive layer 20 has a reflectivity of 45% or more with respect to wavelengths from a red light to infrared light. The adhesive layer 20 is, for example, one of Cr, Ti, Ta, TiSi₂. The high reflection layer 30 is one of Ni, Cu, Au, Al and Ag.

The scale gratings 40 have only to be a metal. For example, it is preferable that the scale gratings 40 are made of a metal different from the high reflection layer 30. It is more preferable that the scale gratings 40 are made of the same metal as the adhesive layer 20. The protective layer 50 has only to be a transparent material. The protective layer 50 is, for example, a transparent resin material, inorganic transparent material or the like. The protective layer 50 has a diffraction index of 1.3 to 1.6.

In the embodiment, phase gratings are structured with the high reflection layer 30 and the scale gratings 40. It is therefore possible to use the scale 100 as a reflection type scale.

Next, the high reflection layer 30 has a high reflectivity. It is therefore possible to achieve high diffraction efficiency. For example, when the high reflection layer 30 has a reflectivity of 80% or more with respect to the wavelength of the used light, high diffraction efficiency can be achieved. In this case, even if the protective layer 50 is provided and reflection or absorption occurs, it is possible to achieve sufficient diffraction efficiency.

Next, both the high reflection layer 30 and the adhesive layer 20 are made of a metal. Therefore, high adhesion is achieved between the high reflection layer 30 and the adhesive layer 20. Both the scale gratings 40 and the high reflection layer 30 are made of a metal. Therefore, high adhesion is achieved between the scale gratings 40 and the high reflection layer 30. Moreover, the adhesive layer 20 has high adhesion with the substrate 10. Therefore, high adhesion is achieved with the substrate 10.

Next, when the scale gratings 40 and the high reflection layer 30 are made of a different metal, the high reflection layer 30 acts as an etching stop during forming the scale gratings 40 by etching. In particular, when the scale gratings 40 and the adhesive layer 20 are made of the same metal, a number of types of materials may be reduced. It is therefore possible to suppress the deposition cost of a deposition device. For example, even if the scale gratings 40 and the adhesive layer 20 are made of the same metal, sufficient diffraction efficiency is achieved by using a metal of which a reflectivity is 45% or more with respect to the wavelength of the light.

Next, when the protective layer 50 covers the high reflection layer 30 and the scale gratings 40, it is possible to suppress damaging of the high reflection layer 30 and the scale gratings 40, adhering of a contaminant and so on. For example, when the protective layer 50 has a diffraction index of 1.3 to 1.6, sufficient diffraction efficiency is achieved.

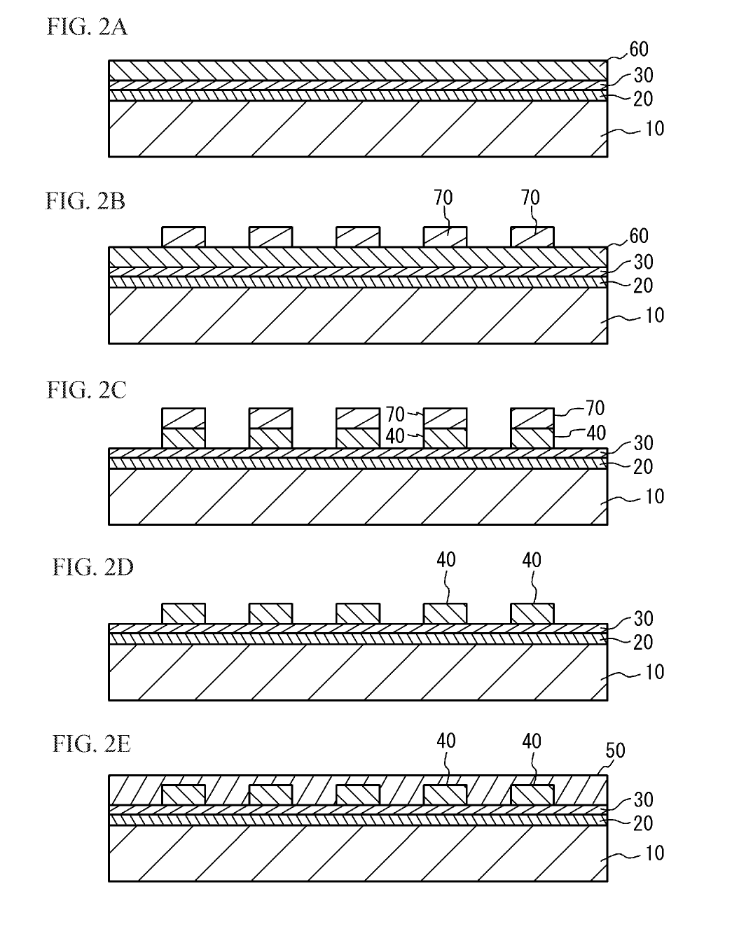

FIG. 2A to FIG. 2E illustrate a manufacturing method of the scale 100. As illustrated in FIG. 2A, the adhesive layer 20, the high reflection layer 30 and a layer 60 to be etched are formed on a face of the substrate 10 in this order. It is possible to form the adhesive layer 20, the high reflection layer 30 and the layer 60 to be etched by a chemical vapor deposition method, a physical vapor deposition method or the like. The layer 60 to be etched is a layer for forming the scale gratings 40. Therefore, a material of the layer 60 to be etched is the same as that of the scale gratings 40.

Next, as illustrated in FIG. 2B, resist patterns 70 having the same patterns as the scale gratings 40 are formed. Next, as illustrated in FIG. 2C, the resist patterns 70 are used as masks, and the layer 60 to be etched is subjected to an etching process. Thus, the scale gratings 40 are formed.

Next, as illustrated in FIG. 2D, the resist patterns 70 are removed. Next, as illustrated in FIG. 2E, the protective layer 50 is formed so as to cover the high reflection layer 30 and the exposed portion of the scale gratings 40. It is possible to form the protective layer 50 by coating.

In the manufacturing method, phase gratings are structured with the high reflection layer 30 and the scale gratings 40. It is therefore possible to use the scale 100 as a reflection type scale. Next, it is possible to achieve high diffraction efficiency because the high reflection layer 30 has a high reflectivity. Next, high adhesion is achieved between the high reflection layer 30 and the adhesive layer 20, because both the high reflection layer 30 and the adhesive layer 20 are made of a metal. High adhesion is achieved between the scale gratings 40 and the high reflection layer 30, because both the scale gratings 40 and the high reflection layer 30 are made of a metal. Moreover, the adhesive layer 20 has high adhesion with the substrate 10. Therefore, high adhesion is achieved with the substrate 10.

Next, when the layer 60 to be etched and the high reflection layer 30 are made of a different metal, an etching rate of the layer 60 to be etched is different from an etching rate of the high reflection layer 30. It is therefore possible to use the high reflection layer 30 as an etching stop. In this case, it is possible to control the grating height with high accuracy.

Next, when the scale gratings 40 and the adhesive layer 20 are made of the same metal, the number of material types may be reduced. In this case, the number of targets in a deposition device may be reduced. It is therefore possible to suppress the deposition cost of the deposition device. When a single deposition device is used, it is possible to form the adhesive layer 20, the high reflection layer 30 and the layer 60 to be etched without breaking vacuum.

Next, it is possible to suppress damaging of the high reflection layer 30 and the scale gratings 40, adhering of a contaminant and so on, when the protective layer 50 covers the high reflection layer 30 and the scale gratings 40.

The present invention is not limited to the specifically disclosed embodiments and variations but may include other embodiments and variations without departing from the scope of the present invention.

What is claimed is:

1. A scale comprising:
a substrate;
a first metal layer formed on the substrate;
a second metal layer formed on the first metal layer; and
scale gratings that are formed on the second metal layer and have a plurality of metal gratings at a predetermined interval,
wherein the first metal layer is made of a first metal,
wherein the second metal layer is made of a second metal,
wherein adhesion of the first metal with the substrate is higher than adhesion of the second metal with the substrate, and
wherein a reflectivity of the second metal with respect to a wavelength of a used light is higher than a reflectivity of the first metal layer with respect to the wavelength of the used light.

2. The scale as claimed in claim 1, wherein the second metal layer has a reflectivity of 80% or more with respect to wavelengths from a red light to an infrared light.

3. The scale as claimed in claim 1, wherein the first metal layer is one of Cr, Ti, Ta and TiSi₂.

4. The scale as claimed in claim 1, wherein the second metal layer is one of Ni, Cu, Au, Al and Ag.

5. The scale as claimed in claim 1, wherein the scale gratings are made of a metal that is different from the second metal of the second metal layer, and
wherein the scale gratings have a reflectivity of 45% or more with respect to wavelengths of a red light to an infrared light.

6. The scale as claimed in claim 5, wherein the scale gratings are made of the same metal as the first metal layer.

7. The scale as claimed in claim 1, further comprising a protective layer that covers the scale gratings and have a diffraction index of 1.3 to 1.6.

8. A manufacturing method of a scale comprising:
forming a first metal layer, a second metal layer, and a metal scale grating layer on a substrate in this order; and
forming scale gratings having a plurality of metal gratings at a predetermined interval, by etching the metal scale grating layer,
wherein the first metal layer is made of a first metal,
wherein the second metal layer is made of a second metal,
wherein adhesion of the first metal with the substrate is higher than adhesion of the second metal with the substrate, and
wherein a reflectivity of the second metal with respect to a wavelength of a used light is higher than a reflectivity of the first metal layer with respect to the wavelength of the used light.

9. The method as claimed in claim 8, wherein the second metal layer is made of a metal that is different from the metal scale gratings layer, and
wherein the second metal layer is used as an etching stop layer during the etching.
